(19) United States
(12) Patent Application Publication
(10) Pub. No.: US 2021/0206199 A1
(43) Pub. Date: Jul. 8, 2021

(54) Airfoil Wings and/or Fan-Like Blades Affixed to Automobile Wheels for the Extraction of Wheel Well Air Pressure and Brake Cooling

(71) Applicant: Chet Baigh, CHICAGO, IL (US)

(72) Inventor: Chet Baigh, CHICAGO, IL (US)

(21) Appl. No.: 16/735,623

(22) Filed: Jan. 6, 2020

(51) Int. Cl. B60B 7/20; F04D 29/28; B60B 7/00; F16D 65/12; B60T 5/00

(52) U.S. Cl. CPC B60B 7/20; F04D 29/281; B60B 19/10; F16D 65/128; B60T 5/00; B60B 7/0086

(57) ABSTRACT

The present invention relates to a plurality of airfoil rim wings, and/or fan-like blades which may be flat or take the form of airfoil wings in a preferred embodiment are attached to an automobile's wheel rims for the extraction of air pressure buildup within the wheel wells during forward movement to improve overall performance, styling and brake cooling. The airfoil rim wings, and/or fan-like blades may either be adhered to a wheel surface or individually or collectively fastened to wheels' hub using open-ended lug nuts, and securing lug bolts. Further, the airfoil rim wings, and/or fan-like blades may be arranged to specific concavity and angel of attack using twistable beveled washers on both sides of the airfoil rim wings, and/or fan-like blades.

### CROSS REFERENCE TO RELATED APPLICATIONS

This application claims the benefit of U.S. Provisional Application No. 62/788,940, filed Jan. 6, 2019.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

Often, automotive industry seeks products which reduce an automobile's (“automobile,” as defined by any automobile, “auto,” “car,” truck, and/or any other wheeled transport) “aerodynamic drag” (“AD”), and/or brake cooling for long-lasting braking performance. One embodiment of the ARWs are affixed to the hardened wheel structures (the “rim”) in a fan-like arrangement to force airflow out of the wheel wells through the openings of the rim made available by the spaces between the existing hardened rim spokes. When a car moves forward, the wheel wells act similarly to parachutes which cause air pressure buildup and aerodynamic drag. Lessening the air pressure in the wheel well will reduce the drag caused by the wheel well. This will increase the car's fuel and/or battery efficiency, increase acceleration, reduce lift and allow for more downforce, increase the top speed, lower brake components' temperature, increase brake components' lifespan, increase braking systems' performance, reduce the effects of the leading wall of the wheel well's vortices, vacuum, turbulence and/or drag.

### TECHNICAL FIELD

The present invention relates to a plurality of airfoil rim wings, and/or fan-like blades which may be flat or take the form of airfoil wings in a preferred embodiment are attached to an automobile's wheel rims for the extraction of air pressure buildup within the wheel wells during forward movement to improve overall performance, styling and brake cooling. The “airfoil rim wings” (“ARW”) (“ARW(s)”) and “fan-like blades” differ primarily by ARW(s) having an airfoil cross section, and fan-like blades relying on an angle of attack, and thus, the two terms may be interchangeable in every contextual case herein which does not specifically rely on the airfoil feature comprising or not comprising an embodiment of the present invention) are either adhered to the body and/or bolted on to the wheel lug nut bolts using open-ended lug nuts and an additional securing bolt so that the ARW(s) and/or fan-like blades may be applied to and fit more universally to the many differing existing and future automobile rim and wheel geometries. Embodiments of the present invention allow for one or more of affixed arrangements onto the wheel rims which include, but is not limited to, a circular, radiant, offset, flat concave convex, overlapping, spiraling, fashions and/or having one or more of angles of attack. The addition of an airfoil cross section to a fan-like blade will allow for extra force applied to the air while maintain a lesser angle of attack and thus less drag caused by the invention itself.

### BACKGROUND ART

The invention relating to the Upper wheel fairing reducing critical vehicle drag pertains to some aspects to the present invention. Like the present invention titled, “Airfoil Wings and/or Fan-Like Blades Affixed to Automobile Wheels for the Extraction of Wheel Well Air Pressure and Brake Cooling,” the invention works do reduce vehicle drag by altering wheel well aerodynamics. However, the background invention provides a fixed, non-rotational wheel well covering such that an internal wheel is less affected by forward airflow drag. The present invention utilized rotating wing-like and/or fan-like structures to force air out of an automobile's existing wheel wells.

### SUMMARY OF PRESENT INVENTION

These embodiments of the present invention provide a plurality of fan-like blades, including the preferred airfoil wing embodiments [“ARW(s)”) are defined herein as having more advantageous features, a preferred embodiment and/or subcategory of “fan-like blade(s)” and my be used interchangeably herein, and specifically in all contexts which the widest scope of the present invention is achieved, including but not limited to instances herein where the subcategory ARW(s) are solely referred (examples being ARW, ARW(s), ARW(s) and/or other iterations), yet can include the parent fan-like blades] which are affixed to the existing rims of an automobile for the extraction of air pressure buildup within the wheel wells and brake cooling during forward movement. Each ARW comprises a flatter outward-facing top surface than the in-ward facing bottom surface to allow for a pressure differential between the two sides. The airfoil system creates sideways “lift” and forces air from the inside of the wheel well to the outside while causing minimal drag from the ARWs. An embodiment also may affix the ARWs with a tilted angle of attack in the direction of the wheels' forward rotation to act similarly to a fan and/or a propeller. This also maximizes the outward thrust provided by the inventive system, and thus its effectiveness. The ARW(s), in the preferred embodiment comprise an airfoil cross section to maximize the force of the airflow and utility of the system. The peak of the substantially more curved surface of the airfoil may have one or more locations moving front to back along the cross section of the ARW(s).

Embodiments of the ARW(s) may be formed as individual ARW(s), or an arrangement where the ARW(s) are connected, such as for use with center-lock wheels. The ARW(s) may be glued to a plurality of spokes of the existing rim, and/or bolted onto the auto's lug nut(s) through a hole(s) in the ARW(s). The ARW(s) may have an integrated beveled surface adjacent to and/or surrounding the area where a lug nut(s) are affixed to create an embodiment utilizing an angle of attack. In an embodiment of the present invention, the angle of attack may be achieved with a plurality of beveled washers sandwiched between the top of the open-end lug nut(s), a flat embodiment of the ARW(s) where the bolt-securing areas of the ARW are flush with and parallel to the top and bottom, and a top lug bolt which secures the sandwiched items. The beveled washers may be turned to create a flat, concave and/or convex arrangement of the system to conform to the existing wheel(s') geometry and/or to suit the users' style preference. An embodiment of the present invention comprises a plurality of ARW(s) without bolt holes which may be affixed to the rim by the methods of adhering the ARW(s) using glue/adhesive directly to the spoke(s), rim hub(s) and/or other solid areas. One or more of wall structures may also be adhered and/or screwed to the ARW(s) and separately to the rim's structures such that an appropriate gap between the ARW(s) and the rim structures is achieved for appropriate airfoil function when utilizing an adhered embodiment of the AWR(s). Further, these walls may have a wedge shape to produce a desired angle or attack. The walls may also form one or more of bridge(s) across adjacent spokes and other rim areas which are close to one another. An intermediary protective bonding layer (“IPBL”) may also be used for easily removing the ARW(s) without damaging the rim(s).

An embodiment of the present invention includes a wheel rim which has a plurality of ARW(s) having a properly directional airfoil cross section designed to be integrated into the rim itself. The ARW(s) may be permanent or removable.

Embodiments of the present invention may utilize active aerodynamics (“active-aero”) to change the ARW(s) angle of attack, position, angle of sweep, integrated aileron and/or flap positioning, concavity, center of gravity and/or other likely moveable configurations to conform to desired and/or changing driving conditions. Certain active aero elements of the present invention which would be desirable, yet not limited to hinges, pivots and/or other features moved by servos, hydraulics, gears and/or other methods and embodiments of the present invention fall within the scope of the present invention regardless of whether they are illustrated herein. These elements may also be adjustable to fixed positions manually, and also be bound by this invention's scope whether this may be construed fall short of the intelligence of automated active-aero conceptualizations. Embodiments of the present invention may contain active-aerodynamic properties activated by one or more of centrifugal governors. Centrifugal governors, while by intuition of someone skilled in the art, would be normally hinged and/or spring-loaded, centrifugal governors may be solid weighted leveraged structures which cause a centrifugal force which activates one or more of activation of aerodynamic geometries. One or more parts of the ARW(s) may be torqued by the fixed governors and be flexible enough, spring-loaded hinged, and/or jointed such that alternate aerodynamic geometries occur with greater or lesser centrifugal forces. Further refinement of certain embodiments may cause the centrifugal governors to account for and utilize the additional Earthen gravity along the bottom-most areas of sweeping motion of generally vertical rotation. Other standard active aero parts may be actuated to account for differing positions along the vertical rotational sweep areas. Embodiments of the present invention may incorporate activated differing aerodynamic geometries among differing positions along the rotational sweep areas for reasons including, but not limited to net downforce, and/or reducing forward movement drag. These embodiments of the present invention fall within the scope of the present invention regardless of whether they are illustrated herein. Electricity-driven embodiments of active-aero function and communication may be powered by, but not limited to, the car's own electrical system, and/or electrical systems on individual ARW(s) which may comprise an onboard battery, small wind turbine generators, centrifugal geared generator systems, piezoelectric pressure centrifugal systems, solar power photovoltaics, air pressure reservoirs, leverage, tracked guides along non-rotating areas, and/or other methods.

The ARW(s) may be made of any suitable material. The plurality of material constituting the ARW(s) may be composite, metal, plastic, rubber, fiberglass, hybrid materials, and/or reinforcement structures. Any combination of material may also be used, layers and/or cores which may add supplementary attributes. For example, one embodiment may include one or more ARW(s) composed primarily of carbon fiber, and/or forged carbon fiber with one or more of reinforcement layers made of one or more of material types including, but not limited to metal, metal mesh, Kevlar, aramid, aluminized fibers, hybrids thereof, and may include one or more of additional cores along the length made of fiberglass and/or any other material. With regard to fibrous composites any weave, unidirectional, multidirectional, randomized and/or combination may be used. Replaceable hardened leading edge protective cover(s) may be affixed to the ARW(s) leading edge by adhesion and/or fasteners to protect the ARW(s) from rock chips and other potential aversive occurrences. Additional embodiments of leading-edge covering(s) may also be made from a flexible material like paint protective film, and/or other materials. The covering(s) may also be of greater surface area(s) to prevent curb scrapes when parking.

### BRIEF DESCRIPTION OF THE DRAWINGS

FIG. 1 Is a right perspective view of an automobile wheel well which has a wheel rim with a plurality of ARWs affixed;

FIG. 2 is a bottom view of an ARW;

FIG. 3 is an exploded view drawing of an embodiment of the present invention which depicts a lug nut(s) and lug bolt(s) method for attaching an ARW;

FIG. 4 is an exploded view drawing of an embodiment of the present invention which depicts a method of adhering an ARW to a wheel's rim spoke. illustrates a front perspective view of an automobile which has the IPBL sheet(s) and part(s) bonded to form an assembly which is depicted as being removed without difficulty and/or harming the Paint;

FIG. 5 is a bottom, front view of an example embodiment of the present invention which depicts an ARW with a pushrod active aerodynamic mechanism;

FIG. 6 is a front section view along the line 6-6 from FIG. 2 which illustrates exemplary internal compositions of an ARW;

FIG. 7 is a bottom, front view of an example embodiment of the present invention which depicts an ARW with a geared active aerodynamic mechanism;

FIG. 8 is a bottom, front view of an example embodiment of the present invention which depicts an ARW with centrifugal torsion active aerodynamic mechanism comprising a levered weight;

FIG. 9 is a bottom, front view of an example embodiment of the present invention which depicts an ARW with a hinged and centrifugally forced weight-to-spring active aerodynamic mechanism;

FIG. 10 is a bottom, front view of an example embodiment of the present invention which depicts an ARW with a hinged and centrifugally forced weight-to-spring active aerodynamic mechanism with opposing pivots;

FIG. 11 is a bottom, front view of an ARW which illustrates an exemplary airfoil cross sectional shape;

FIG. 12 is a bottom, front view of an ARW which illustrates an exemplary fan-like blade cross sectional shape;

FIG. 13 is a bottom, front view of an ARW which illustrates an exemplary symmetrical airfoil cross sectional shape;

FIG. 14 is a bottom view of an ARW illustrating a flat surface;

FIG. 15 is a bottom view of an ARW illustrating a center cap cut out;

FIG. 16 is a left side view of an ARW illustrating a flat surface;

FIG. 17 is a left side view of an ARW illustrating a folded surface;

FIG. 18 is a left side view of an ARW illustrating an ARW with an example winglet;

### DETAILED DESCRIPTION OF EMBODIMENTS OF THE PRESENT INVENTION

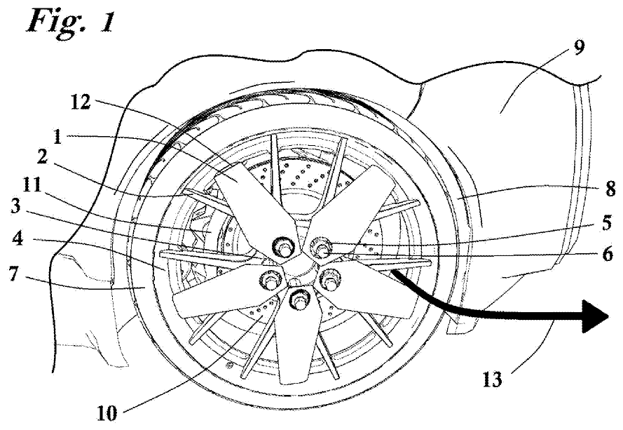

With reference to the drawings shown in FIGS. 1 to 18, the following description regards various example structures, systems, and methods. The systems, structures and methods illustrated compose aspects of the invention which may be implemented and/or practiced. It is to be understood that other specific arrangements of parts, structures, examples, systems, and the like, may be utilized and structural and functional modifications may be made without departing from the scope of embodiments of the present invention.

An embodiment of the present invention primarily describes a plurality of airfoil rim wings 1 [“ARW(s)” which are defined herein as a subcategory of its parental “fan-like blade(s)” 75] attached to an automobile's wheel rims 4 as shown in FIG. 1. Each ARW 1 is shaped as a wing-like surface having an airfoil shape 12 with the side of greater curvature facing the opposite direction of the intended forced airflow 13. As a car 9 moves forward, the interior of the wheel well 8 forms a parachute-like shape causing parasitic drag as a buildup of air pressure. With the assortment of ARW(S) 1 acting as a fan or propeller to extract air 13 from the wheel well interior 8, less air pressure is forced upon the wheel well 8, which lessens drag. As shown in FIG. 1, the wheel comprises firstly a tire 7 fitting around the barrel of the rim 4, and secondly a solid and ridged rim 4 assembly containing a hub 3, a plurality of structural spokes 2. With the additional airflow extraction 13 caused by the ARW(s) rotating with the wheel, the brake assembly, comprising of the rotor 10 and caliper 11 will be cooled, maintain greater braking performance and part longevity.

An embodiment of the present invention as illustrated in FIG. 1 in a right perspective view of a whole assembly, affixes the ARW(s) 1 using a lug nut and bolt 6 assembly. This embodiment, while not necessary, but optionally uses a beveled washer 5 as illustrated in the top view perspective.

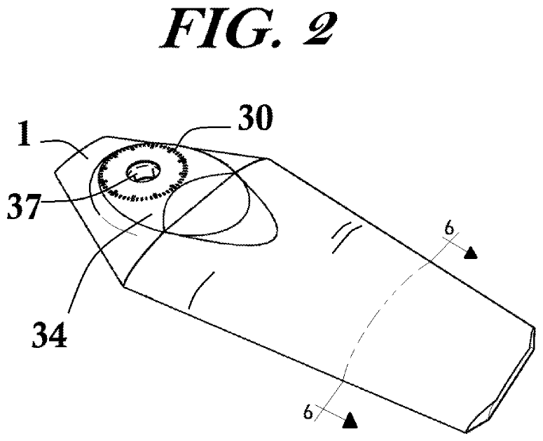

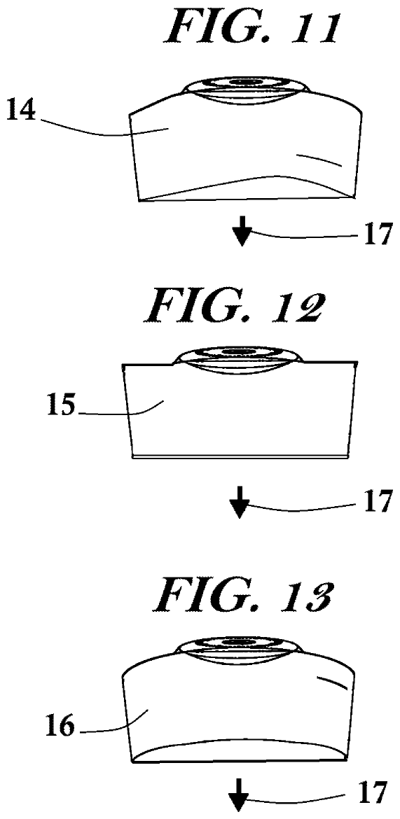

Embodiments of the present invention include ARW(s) 1 with an airfoil shape as shown in FIG. 2. A dial 30 having one or more degree marks may be added to any surface around the bolt hole 37 where a beveled washer may swivel for consistent positioning by a user. The airfoil cross sections illustrated in FIG. 2 induce airflow in the direction to which the airflow arrows 17 point illustrated in FIGS. 11, 12, and 13. FIG. 2 also illustrates an embodiment of an ARW 1 which has a built up and flat-topped plateau 34 which is parallel to the flatter opposite face and/or the plane of sweep the wheel('s) rotation makes. The plateau acts to spread out the compressive force of a tightened open-ended lug nut 21 and top securing bolt 18 and not rely only on the lesser and weaker surface area of the airfoil crest. The plateau may be formed into the structure of the ARW(s) 1 using the same material or be a separate piece(s). The flat-topped plateau 34 may in other embodiments be tilted relative to a plane parallel to the flat circular sweep of the rim 4 rotation to effectively cause one or more angle(s) of attack and/or one or more concavity levels of arrangement.

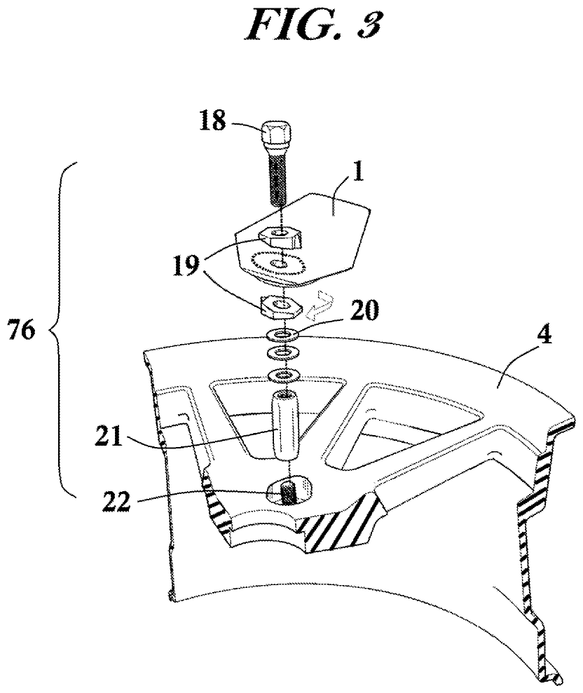

FIG. 3 illustrates an exploded view 76 of an ARW 1 assembly 6. Embodiments of the present invention may include ARW(s) 1 with a hole 37 through which a top securing bolt 18 is tightened to secure to one or more open-ended lug nut(s) 21 as shown in the exploded view 76 illustrated by FIG. 3 of the assembly 6 from FIG. 1. One or more beveled washers 19 may be sandwiched between the top securing bolt 18 and the open-ended lug nut(s). The beveled washer(s) integrated angled faces form various angles of attack for the ARW(s) 1. Also, the beveled washers 19 may be rotated away from a position perpendicular to the length-wise center line of the ARW(s). Rotating the beveled washers before tightening the assembly will cause the collection of ARW(s) to form a concave or convex arrangement within the wheel rim 4, as opposed to flat. The level concavity may be a matter of style preference for the user and/or to match the inherent concavity structure of the donor wheel rim 4. The beveled washers 19 may be made of one or more materials and have one or more faces or be rounded (illustrated only by example herein to have 4 face sides to make a square form when viewed from a top perspective view). One or more additional regular washers 20 may be placed above and/or below any parts to be fastened, including, but not limited to 21, 19, 1, 22, 4 and/or 18. The regular washer(s) 20 may be used to adjust the height of the ARW(s) to clear various parts of the wheel rim 4. With regard to this embodiment of the present invention, one or more open-ended lug nut(s) 21 would first be tightened onto the car's 9 lug nut bolt 22 which affixes the wheel rim 4 to the car's 9 axle(s).

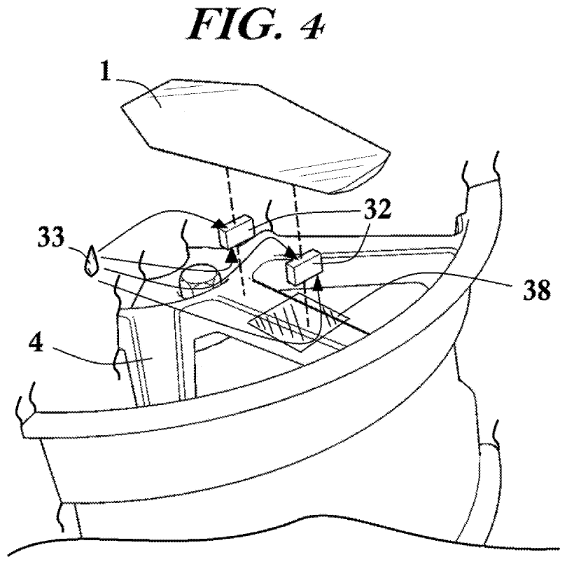

FIG. 4 illustrates an embodiment of the present invention whereby the ARW(s) 1 are adhered directly to the outer surface of the rim spokes 2 and/or the rim hub 3 using an adhesive glue 33. One or more spacer blocks 32 may be used to separate the ARW(s) 1 from the spoke(s) 2 to improve aerodynamic properties. The spacer blocks 32 may be adhered either directly or indirectly to any surface of the rim 4 and/or rim barrel and may additionally implement fasteners connecting the ARW(s) 1 to the spacer blocks 32 for easy removal. The ARW(s) may alternately be adhered directly or indirectly to one or more rim 4 areas without spacer blocks 32. When adhered directly to the spokes 2 and hub 3, the ARW(s) 1 may be made to substantially fan-like geometries. These substantially fan-like geometries rely less on airfoil properties and more on angle of attack, which may include embodiments with leading ARW 1 edges below the plane of the top of the spoke(s) 2, and trailing edges above the plane of the spoke(s) 2, and/or any combination thereof. The block(s) 32 may also be beveled to an angle 31 which, when adhered with the adhesive 33, creates a desired angle of attack for the ARW(s) 1. The adhesive 33 would be applied to both sides of the spacer block 32. In every case where adhesive glue 33 is used. An intermediary protective bonding layer (IPBL) 38 may be used to make removal easier and protect the rim surface from scraping during removal and/or undesired chemical reactions of the adhesive glue 33. An IPBL 38 may consist of “clear bra,” wrap and/or any other segments self-adhering or non-self-adhering film(s). An adhesive 33 and/or spacer blocks 32 and/or fasteners to the spacer blocks 32 and/or an IPBL 38 may be used in concert with embodiments of the present invention which utilize ARW(s) 1 fastened to lug nut bolts 22.

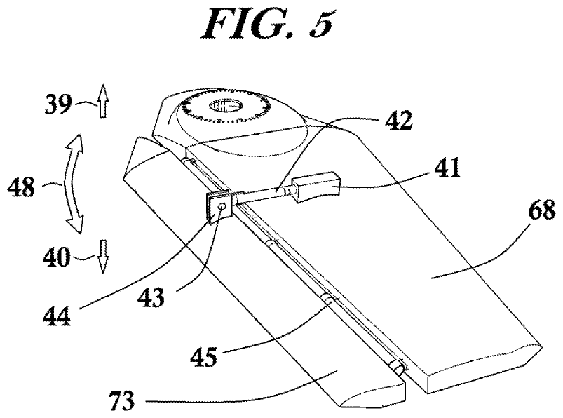

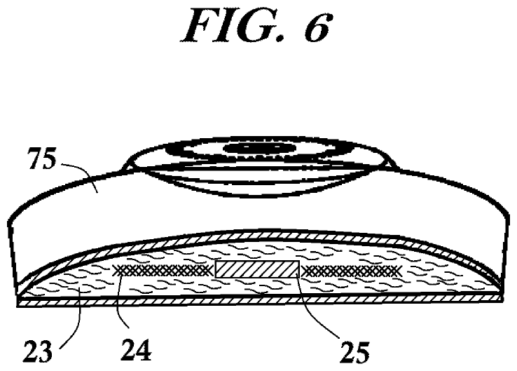

FIG. 6 illustrates exemplary internal compositions of an ARW 1. Embodiments of the present invention may include one or more internal reinforcement structures 23, 24, 25 as illustrated in FIG. 6 to improve the performance of the ARW(s) 1. While a single construction material [and/or composition of material(s)] may always be used, reinforcement structures 23, 24, 25 may add supplementary material traits, such as strength, flexibility, dampening, reduce brittleness, reduce resonant vibrations, filling intricate details, increase lifespan, reduce torsion and/or other benefits. The present invention may include, but not be limited to one or more construction layers and cores as illustrated by 23, 24 and 25 in the cutaway face area of the front section view along the line 6-6 from FIG. 2. The swirly pattern 23 on the outside two top and bottom-most layers of 75 represent the bulk of the mass, as illustrated in this embodiment. For the example of this potential embodiment, the outer layers 23 may be made of carbon fiber, while any material(s) may be used including recycled fibrous paper currency. One or more inner layer(s) 24 may be made of other materials such as a metal mesh screen, Kevlar, aramid, hybrid or any other material which exhibits supplementary structural traits to the differing outer layer(s) 23. As illustrated for this example 75, one or more supplementary core(s) 25 may add beneficial traits. A core(s) 25 may be made of fiberglass, metal, plastic or any other material differing from the outer material 23, and/or any other differing reinforcement material 24. An embodiment of the present invention may contain part(s) or the entire invention made of, yet not limited to these aforementioned materials randomized, forged carbon fiber, and/or other fibers. Randomized forged carbon fiber will likely be advantageous around sharp edges and areas of intricate detail, 23 including washers and fasteners. Forged carbon fiber, and/or any other suitable randomized slurry-like material may be used in conjunction with weaved materials to create parts of multiple, hybrid, materials with similar, separate, connecting, and/or other advantageous areas. Unidirectional fibers positioned perpendicular to the edges, may also be used to fill in sharp edges.

FIGS. 5, 7, 8, 9, and 10 illustrate various embodiments of ARW(s) 1 which incorporate active aerodynamics, adjustable changing aerodynamics and/or any combination thereof. All functional/active-aero embodiments may be attached in one or more fashions and locations, including but not limited to the opposite side of the ARW(s) 1 shown. Embodiment 68 as illustrated in FIG. 5 incorporates an aileron, rudder and/or flap 73 which is hinged 45 so it can be moved up 39, moved down 40, or any combination thereof 48. This embodiment 68 incorporates a mechanical servo housing 41, a pushrod and/or pull rod 42, an axle-like linkage 43 connected to its counterpart axle like linkage 44 which is connected to the aileron 73. As the servo housing 41 pushes and pulls the rod 42, the aileron 73 moves proportionally 48. The servo may consist of a geared servo motor and/or a hydraulic ram. This servo embodiment, along with any other for this purpose may be controlled by an onboard computer system, a mobile device, accelerometer gravitational force sensors, along with any other sensors and or devices, and may be powered and/or communicate using electrical wiring, adjacent batteries, Bluetooth, radio signals and/or any other viable method.

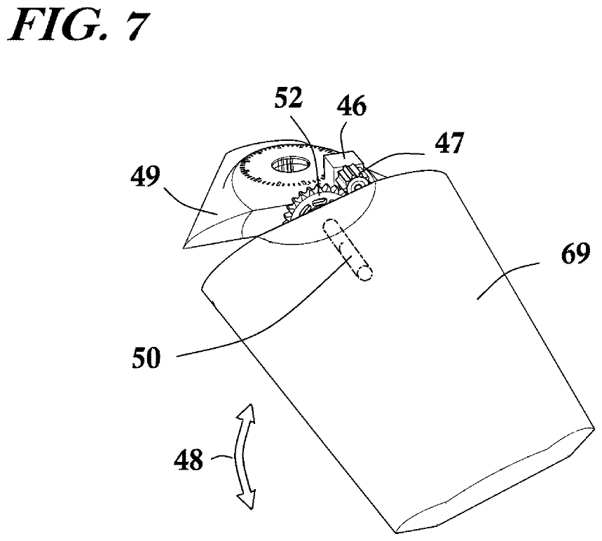

The example embodiment 69 illustrated in FIG. 7 shows a split ARW 69 pivoting on a rotational column 50. The split occurs where attached to the axle-housing-like length 49 is affixed to the rim 4. The rotational column 50 may be rotated by one or more means, but for example is turned by a large gear 52 which is rotated by a smaller gear 47 as it is connected to a servo 46. This assortment produces a movement of a whole section of ARW(s) 1 illustrated by the movement arrows 48.

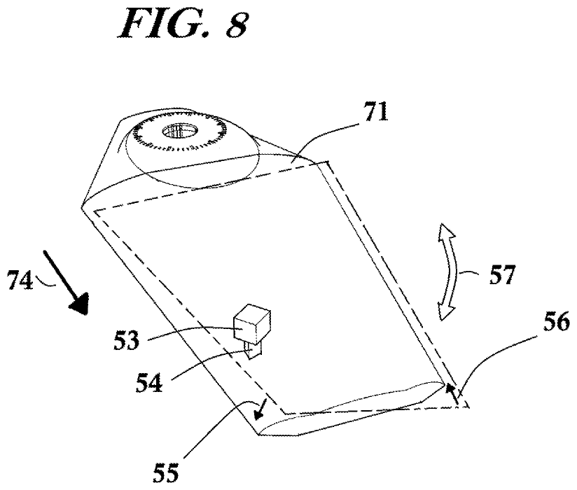

The example embodiment 71 illustrated in FIG. 8 shows an ARW 1, 71 of warping 55, 56 aerodynamic properties based on a centrifugal weight 53 (“centrifugal weights,” or “weights” in that context may be considered a form of centrifugal governors) connected to a leverage stalk 54. When a centrifugal force 74 pulls on the centrifugal weight 53 offset by the leverage stalk 54, a torsional affect warps the ARW 1, 71 when counteracted by centripetal force exerted by the offset body of the ARW 1, 71. This occurs when the car 9 goes faster and the increasing centrifugal force 74 acting on the weight 53 (following the circular path of the inner rim 4) is overcome gradually with increases in revolutions per minute (RPMs). This causes a gradual increasing of warping angle 55, 56, 57 away from the dotted line which suggests the ARW's(s') 1, 71 idle and unaltered position.

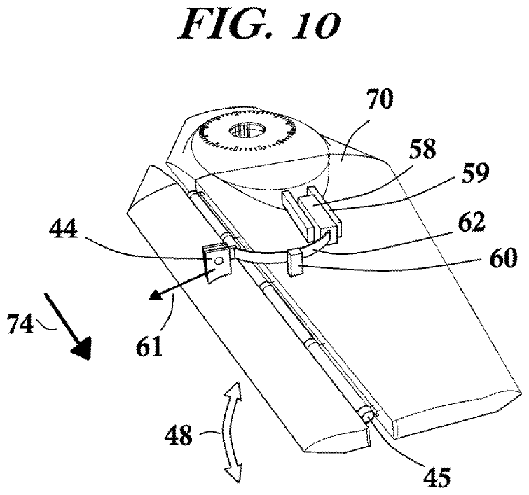

The example embodiment 70 illustrated in FIG. 10 shows an ARW 1, 70 with a hinged 45 aileron 73 which uses a centripetal force 74 weight 58 which is free to move in the direction of the centrifugal force 74 within a guide path housing 59. The centrifugal free-moving weight 58 presses with incremental force upon one end of the (bending or solid) centrifugal arm 62 (likely made of spring steel). The centrifugal arm 62 is anchored 60 at one or more arc crest points. When the rim 4 rotates faster as the car 9 moves faster, the centrifugal force 74 increases causing the weight 58 to move away from the hub 3 along the guide path housing 59 thus pushing the arm 62 into the aileron linkage 44 causing the aileron to tilt 48.

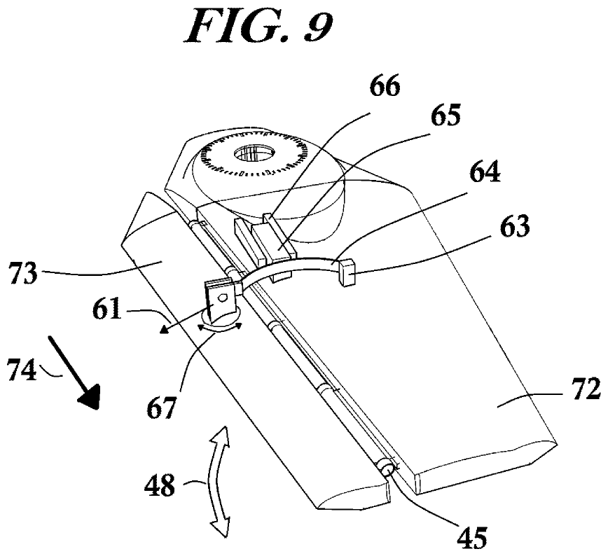

The example embodiment 72 illustrated in FIG. 9 shows an ARW 1, 72 which has a hinged 45 aileron(s) 73 linked to a somewhat mirroring arrangement to that of ARW 70, 1. This embodiment illustrates an anchored 63 centrifugal servo arm 64 (likely bendable having been made of a spring steel, and/or composite) which is press upon by the free-moving centrifugal weight 65 within a guide path housing 66. As the rim's 4 RPMs increase, the centrifugal weight 65 presses on the curved arm 64 causing it to extend into the aileron linkage 67 which may also rotate along the plane of the aileron to free-up additional movement. The straightening of the centrifugal arm causes it to extend away from the anchor 63 causing movement 48 of the hinged 45 aileron 73. When RPMs decrease the inherent spring of the centrifugal arm 64 reclaims its more curved idle geometry and pushes the weight 65 back into the guide housing 66. This action pulls on the aileron 73 linkage 67 causing the aileron 73 to return to its original position.

The airfoil cross section 14 of FIG. 11 illustrates a standard airfoil with a forward crest and flat opposing face. The cross section 15 of FIG. 12 illustrates a substantially flat surface on both top and bottom, thereby forming a fan-like blade shape. The airfoil cross section 16 illustrates an airfoil with a crest at the center of the face and flat opposing face. The airfoil cross section 16 may be advantageous for manufacture due to the airfoil serving multidirectional swings. As such, one ARW 1 may serve both left and right sides of the automobile 9 without the necessity of producing left-handed and/or right-handed types. The fan-like blade having no crest 15 and substantially parallel opposing faces uses primarily an angle of attack to force air in a general direction and/or active aerodynamic functions.

FIG. 14 illustrates a top view of an ARW 1 having a substantially flat exemplary shape 28 of an airfoil.

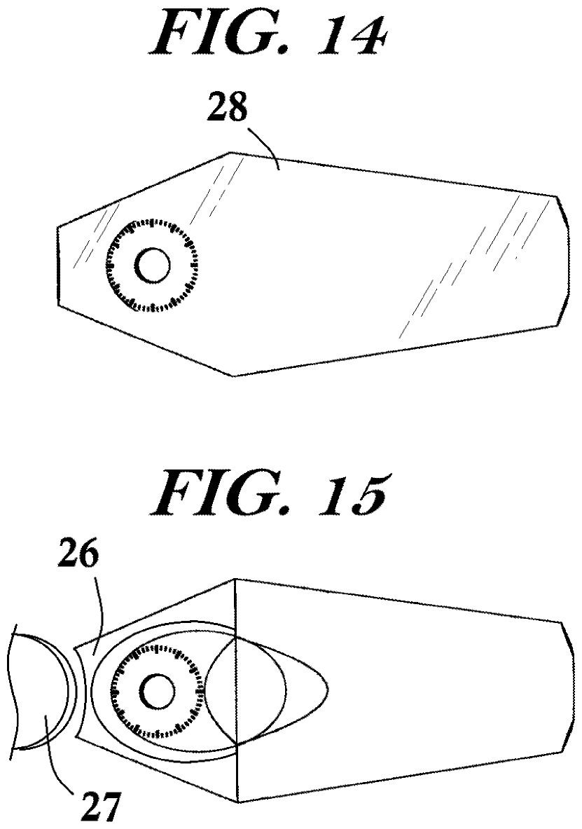

FIG. 15 illustrates top perspective views of the ARW(s) 1 where the edge closest to the hub 3 may be cut out 26 to allow clearance for a raised hub center cap 27 should an elongated embodiment not allow for sufficient clearance. While the ARW(s) 1, 26, 28 illustrated generally form a taper from one end to the other, and varying geometries at each end, alternate embodiments of the present invention may take the form of, yet not be limited to, rectangular, widening, offset, angled, multiple tapers, curved, having one or more angles which may or may not be radians of the center of curvature of the rim 4 circle, or any other geometry, including being connected to one another, and spanning the entire diameter of the wheel and/or rim.

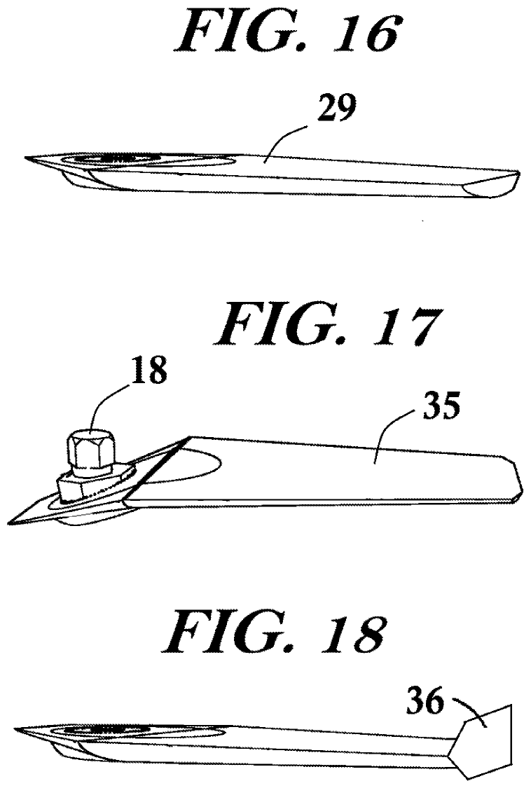

As illustrated in FIGS. 16, 17, and 18 using a left perspective view, one or more ARW 1 shapes 29, 35, 36 may be desirable. Certain embodiments of the present invention may comprise a flat lengthwise ARW 29 shape, as illustrated in FIG. 16. An ARW 1 may also exhibit a curve along its length.

As illustrated in FIG. 17, an ARW embodiment may comprise a length with one or more angles, joints, creases and/or folds 35. An embodiment of the present invention may include one or more wingtip devices 36 as illustrated in FIG. 18. Wingtip devices may help eliminate drag and vortices and may take the forms of, yet not be limited to wing end-plates, Hoerner wing tips, winglets, wingtip fences, canted winglets, blended winglets, raked wingtips, split-tips, non-planar wingtips, actuating wingtips, and/or active-aero wingtips. Further embodiments may include, but not limited to wingtip devices which have a curved face from the leading point to the trailing point which closely matches the smaller natural circumference curve of the inner or outer wheel rim or vortex generators along the bottom spine. A curved embodiment of the wingtip device 36 may be desirable to conform to the sweep radius of the ARW(S) 1 within the confines of the wheel, such that small vortices, turbulence, drag and vacuum areas form at the wingtip device. Other embodiments of the present invention may utilize a weighted wingtip device 36 to add a tensile force to the ARW(s) due to centripetal and centrifugal forces caused by the wheels' rotation. Other embodiments of the present invention include but are not limited to ARW(s) 1 which each have a plurality of blades in one or more arrangements which may include stacking ARW(s) 1 on top of each other, and/or making ARW(s) 1 of one or more connected structure(s).

The exemplary embodiments shown and described above are only examples.

Many details are often found in the art such as the other features of a fan-like addition to a wheel's(s') rim. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. An apparatus for reducing air pressure in an automobile's wheel well(s) and/or brake cooling, comprising:
one or more fan-like blade(s) and/or airfoil rim wing(s) arrangements which are adhered to, and/or fastened to the non-flexible part(s) of various types of existing and future automobile wheels such that the forward rotation of the wheel causes the fan-like blade(s) and/or airfoil rim wing(s) to force air in one or more intended directions, and
an arrangement of fan-like blade(s) and/or airfoil rim wing(s) which may have one or more angles of attack and/or an airfoil cross section having opposing faces of differing curvatures which independently and/or together maximally force air in one or more directions when in motion.

2. The apparatus of claim 1 wherein one or more of the fan-like blade(s) and/or airfoil rim wing(s) are directly and/or indirectly fastened to the same fasteners which hold the wheel rim to the automobile's axle(s), axle shaft assembly(ies), and/or axle hubs(s), which may comprise, but not be limited to one or more threaded fasteners, lug nuts, lug bolts, wheel studs, wheel bolts, lug nut bolt holes, spline lug bolts, open-ended lug nuts, extended open-ended lug nuts, extended open-ended lug nuts with threaded spike tops, locking lug nuts, locking lug bolts, locking wheel bolts, wheel stud converters, center lock wheels and hubs which would utilize a centrally connected fan-like blade(s) and/or airfoil rim wing(s) arrangement, wheel stud size converters, fastening holes in the axle hub(s), fastening holes in the wheel rim(s) unthreaded washers, threaded washers, threaded beveled washers and/or unthreaded beveled washers, all of which may be made from one or more materials.

3. The apparatus of claim 2 wherein beveled washers are used above and/or below the fan-like blade(s) and/or airfoil rim wing(s), and in between the fastening lug bolt and open-ended lug nut to create one or more angles of attack, and when twisted, said beveled washers also cause each fan-like blade and/or airfoil rim wing to tilt upward or downward to form one or more optional concave, flat and/or convex arrangements of the collective arrangement of fan-like blade(s) and/or airfoil rim wing(s) relative to the circular plane of the wheel.

4. The apparatus of claim 2 wherein each fan-like blade and/or airfoil rim wing may be affixed to the rim with one or more angle(s) of attack and/or arrangement concavity formed by one or more built up plateau(s) on the top and/or bottom faces of the fan-like blade(s) and/or airfoil rim wing(s) which are not parallel to the top-view plane of the said fan-like blade(s) and/or airfoil rim wing(s).

5. The apparatus of claim 1 wherein one or more fan-like blade(s) and/or airfoil rim wing(s) may be adhered to the existing hardened surfaces of an automobile's wheel and/or rim using a plurality glues and/or glue-like adhering materials including but not limited to one or more intermediary protective bonding layer(s), spacer block(s), fasteners, and/or beveled spacer block(s).

6. The apparatus of claim 1 wherein multiple embodiments of the present invention comprise one or more apparatuses, systems, machines and/or methods to implement active aerodynamics, wireless and/or wired communication of active aerodynamics, centrifugally governed, and/or adjustable aerodynamics to change the airfoil rim wing's(s') and/or fan-like blade's(s') angle of attack, position, angle of sweep, integrated aileron and/or flap positioning, tilt, concavity, warpage, spring(s), weight(s), spring arm(s), differing positions along one or more areas of a wheel's sweep areas, center of gravity and/or one or more other moveable configurations which may be powered by one or more systems including but not limited to, electricity, batteries, solar photovoltaics, wind turbine generators, springs, hydraulics, gears, piezoelectric generators, chemical, air pressure reservoirs, leverage, tracked guides along non-rotating areas, and/or centrifugal systems.

7. The apparatus of claim 1 wherein one or more of the fan-like blade(s) and/or airfoil rim wing(s) having a hole at one end through which a securing lug bolt is threaded and screwed into the top of an installed open-ended lug nut which has threads within the said open end.

8. The apparatus of claim 1 wherein each fan-like blade and/or airfoil rim wing are separately fastened to each lug bolt and/or open-ended lug nut of an automobiles wheels.
